(19) United States
(12) Patent Application Publication
(10) Pub. No.: US 2026/0334354 A1
(43) Pub. Date: Oct. 29, 2026

(54) MATERIAL SPREADER TRANSFER BALANCE SYSTEM AND METHOD

(71) Applicant: George A Palmer LTC, Charles Walters Equipment, New Lenox, IL (US)

(72) Inventors: Michael Palmer, Peckleton (GB); Marco Valier, Pino Torinese (IT)

(21) Appl. No.: 19/546,487

(22) Filed: Feb. 23, 2026

Related U.S. Application Data
(60) Provisional application No. 63/762,869, filed on Feb. 25, 2025.

(51) Int. Cl. A01C 17/00

(52) U.S. Cl. CPC A01C 17/008

(57) ABSTRACT

A material spreader includes a hopper defining an interior that contains material, and defining an opening that discharges the material from the interior by gravity. The material spreader also includes a plate positioned below the opening, wherein the plate defines at least one aperture that guides material flow from the hopper. The material spreader also includes a damper that selectively occludes the at least one aperture from the opening in a direction of gravity based on user input. The material spreader also includes an impeller positioned below the damper.

### CROSS REFERENCE TO RELATED APPLICATIONS

The application claims priority to and the benefit of U.S. Provisional Patent Application No. 63/762,869, filed on Feb. 25, 2025, entitled “MATERIAL SPREADER TRANSFER BALANCE SYSTEM AND METHOD”, the entirety of which is incorporated herein by reference.

### BACKGROUND

Material spreaders are widely used in agricultural, landscaping, and industrial applications to distribute granular materials, such as fertilizers, seeds, de-icing salts, and other particulate substances. These spreaders typically utilize an impeller to propel the material outward in a dispersal pattern over a target area. The effectiveness of a material spreader depends not only on the consistency of material flow from the hopper but also on the controlled delivery of material onto the impeller to achieve a uniform and predictable spread pattern.

In conventional spreaders, material is generally discharged from the hopper onto the impeller with limited control over the precise placement, timing, or direction of the material flow. As a result, variations in material discharge, including inconsistent flow rates and off-center distribution onto the impeller, can lead to uneven spreading patterns, excessive material waste, and reduced application efficiency. These issues are particularly pronounced when dealing with materials of varying particle sizes, densities, or moisture content, which can affect the trajectory and acceleration of the granules as they make contact with the impeller blades.

Existing spreader designs often rely on gravity-fed mechanisms or rudimentary flow regulators, such as adjustable gates or deflectors, to direct material onto the impeller. However, these passive approaches provide limited precision in controlling material trajectory, leading to asymmetrical or unpredictable spreading patterns. Additionally, external factors such as terrain slope, vibration, or variations in material properties can further influence the flow path of the material, exacerbating inconsistencies in distribution.

The inability to effectively control material delivery onto the impeller not only reduces application efficiency but also increases operational challenges. In agricultural and landscaping applications, improper distribution of fertilizers or seeds can result in under-or over-application in certain areas, negatively impacting crop yield and resource utilization. Similarly, in de-icing operations, uneven salt distribution can lead to unsafe road conditions or excessive material usage, increasing costs and environmental impact.

Also, certain material spreader designs employ deflectors to achieve border control by diverting material throw direction away from non-target areas, however, these devices present significant challenges. Because deflectors function by passively redirecting granular material upon impact, they often result in an unintended double dosing effect whereby material deflected from one side accumulates on the opposite side. This redirection not only disrupts the uniformity of a resulting spread pattern but also compromises the overall precision of material distribution. Moreover, the passive nature of deflectors makes them less adaptable to variations in flow rate, particle characteristics, and environmental conditions, leading to further inconsistencies in application efficiency and increased material waste.

### BRIEF DESCRIPTION

According to one aspect, a material spreader includes a hopper defining an interior that contains material, and defining an opening that discharges the material from the interior by gravity. The material spreader also includes a plate positioned below the opening, wherein the plate defines at least one aperture that guides material flow from the hopper. The material spreader also includes a damper that selectively occludes the at least one aperture from the opening in a direction of gravity based on user input. The material spreader also includes an impeller positioned below the damper.

According to another aspect, a transfer balance system includes a plate that defines at least one aperture, and includes anchors. The transfer balance system also includes a slide fixed with the plate in a top-bottom direction, and the slide includes a damper. The transfer balance system also includes a user actuated adjustment mechanism that drives the slide relative to the plate in a left-right direction orthogonal to the top-bottom direction through a manual user input, where the damper selectively occludes the at least one aperture in the top-bottom direction based on the user input.

The innovation described herein provides a device for directing material flow onto an impeller, ensuring reliable and efficient dispersal from a hopper. In addition to other described features, functions, and benefits, the device improves control over material trajectory and placement onto the impeller, minimizing inconsistencies in distribution. Furthermore, the device helps shield critical components from exposure to granular materials, reducing wear and enhancing overall system durability.

### BRIEF DESCRIPTION OF THE DRAWINGS

FIG. 1 is a front perspective view of an example material spreader in accordance with aspects of the innovation.

FIG. 2 is a top perspective view of an example transfer balance system included in the material spreader of FIG. 1.

FIG. 3 is a bottom view of the transfer balance system of FIG. 2.

FIG. 4 is a back perspective view of the transfer balance system of FIG. 2.

FIG. 5 is an exploded perspective view of the transfer balance system of FIG. 2.

FIG. 6 is a top perspective view of another example transfer balance system included in the material spreader of FIG. 1.

### DETAILED DESCRIPTION

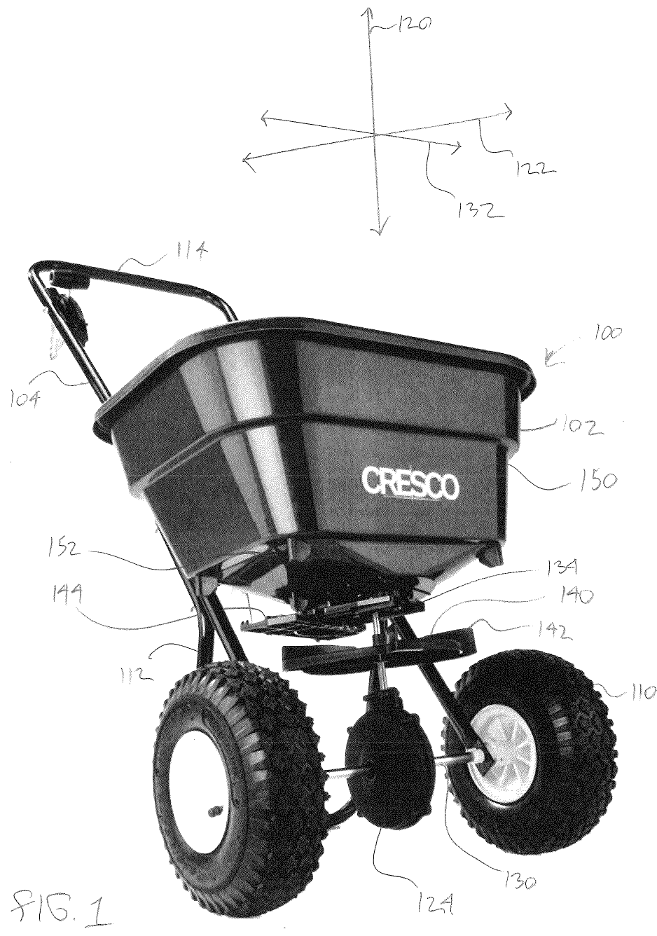

It should, of course, be understood that the description and drawings herein are merely illustrative and that various modifications and changes can be made in the structures disclosed without departing from spirit and scope of the present disclosure. Referring now to the drawings, wherein like numerals refer to like parts throughout the several views, FIG. 1 depicts a material spreader 100 including a hopper 102 supported on a frame 104 with a set of wheels 110 and a leg 112. The frame 104 forms a handle 114 above the hopper 102 in a top-bottom direction indicated by a first arrow 120. The frame 104 also forms the handle 114 behind the hopper 102 in a front-back direction perpendicular to the top-bottom direction, indicated by a second arrow 122. With this construction, the material spreader 100 is a walk-behind spreader or a push spreader that may be pushed or pulled by a user over a target area such as a lawn or field, where the material spreader 100 disperses granular material from the hopper 102.

The wheels 110 are operably connected to a mechanical drive 124 across an axle 130 such that pushing or pulling the material spreader 100 in the front-back direction at the handle 114 rotates the wheels 110 and the axle 130 about a left-right direction perpendicular to the top-bottom direction and the front-back direction, indicated by a third arrow 132. The mechanical drive 124 transfers rotational forces from the axle 130 to a shaft 134, causing the shaft 134 to rotate about the top-bottom direction. While, as depicted, the mechanical drive 124 is a gear-driven mechanism, the mechanical drive 124 may additionally or alternatively include a chain and sprocket system or a variety of devices that rotate the shaft 134 with power from the axle 130 without departing from the scope of the subject disclosure.

The material spreader 100 includes an impeller 140 fixed with the shaft 134. The impeller 140 includes blades 142 extended radially outward from the shaft 134 in the front-back direction and the left-right direction. The blades 142 rotate with the shaft 134 about the top-bottom direction, and disperse granular material from the hopper 102 radially outward from the material spreader 100. In this manner, the shaft 134 is a cylindrical drive shaft that transfers torque from the wheels 110 to the impeller 140.

With continued reference to FIG. 1, the shaft 134 extends upwards from the mechanical drive 124, through the impeller 140 and a transfer balance system 144, and into the hopper 102 in the top-bottom direction. The hopper 102 is formed from a wall 150 that defines an interior, an exterior, and an opening at a bottom side 152 from the interior to the exterior of the hopper 102. With this construction, granulated materials such as, for example, fertilizer, salt, or chalk may be contained in the interior by the wall 150, and discharged from the interior through the opening by gravity.

The transfer balance system 144 is mounted to the bottom side 152 of the hopper 102, beneath the opening in the top-bottom direction. As such, the transfer balance system 144 is interposed between and separates the opening and the impeller 140 in the top-bottom direction. The top-bottom direction corresponds to a direction of gravity when the material spreader 100 is upright and in use traversing a horizontal surface that extends in the left-right direction and the front-back direction. With this construction, the transfer balance system 144 is positioned along a flow of materials guided by gravity from the opening to the impeller 140.

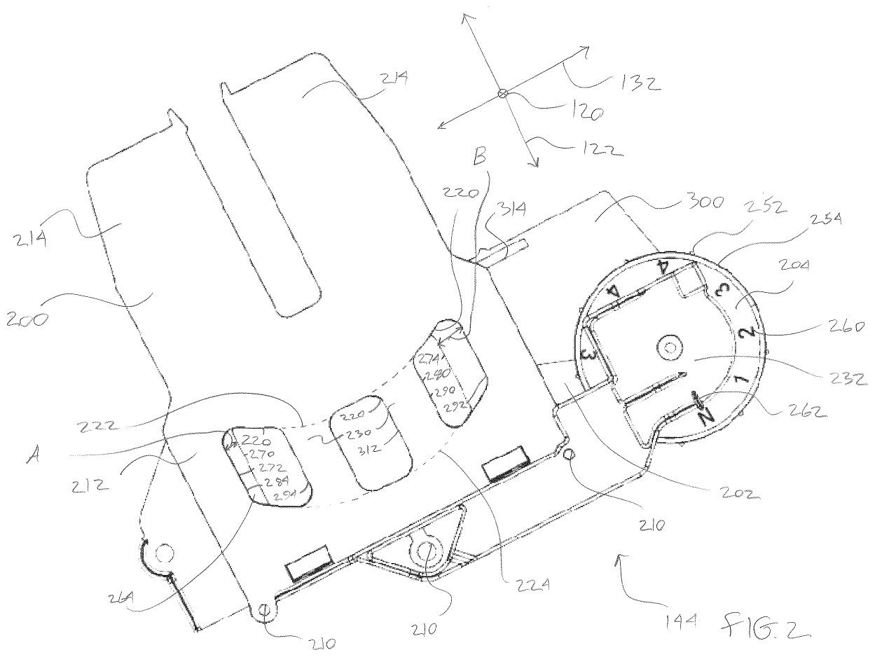

FIG. 2 depicts a top perspective view of the transfer balance system 144. As shown in FIG. 2, the transfer balance system 144 includes a plate 200, a slide 202, and a wheel 204. The wheel 204 operably connects the plate 200 to the slide 202 such that rotating the wheel 204 about the top-bottom direction relative to the plate 200 actuates the slide 202 in the left-right direction relative to the plate 200 and the wheel 204. Rotation of the wheel 204 by a user is a manual user input that drives the slide 202 in alternative linear directions along the left-right direction. In this regard, rotating the wheel 204 in a first rotational direction about the top-bottom direction actuates the slide 202 in a first linear direction in the left-right direction, and rotating the wheel 204 in a second rotational direction opposite the first rotational direction actuates the slide 202 in a second linear direction opposite the first linear direction. In this manner, the wheel 204 forms a user actuated adjustment mechanism that drives the slide 202 relative to the plate 200, controlling a left-right position of the slide 202 relative to the plate 200 through manual user input.

The plate 200 includes anchors 210 complementary to the bottom side 152 of the hopper 102 for mounting the plate 200 across the opening. While, as depicted, the anchors 210 are through holes reinforced with bosses formed from the plate 200, where the through holes receive fasteners (not shown) that mate with the wall 150 at the bottom side 152 of the hopper 102, the anchors 210 may additionally or alternatively include undercuts, inserts, recesses, fasteners, snap-fit features, or other mounting devices that rigidly fix the plate 200 with the hopper 102 without departing from the scope of the present disclosure.

The plate 200 forms a main body portion 212, and fins 214 that extend outward from the main body portion 212 in the front-back direction. The fins 214 are offset from each other along a same side of the main body portion 212 in the left-right direction. With this construction, when the plate 200 is assembled with the hopper 102 as shown in FIG. 1, the fins 214 contact and press against the bottom side 152, across the shaft 134 in the front-back direction, and at either side of the shaft 134 in the left-right direction. As such, the fins 214 stabilize the plate 200 on the bottom side 152 of the hopper 102 around the shaft 134 in the front-back direction and the left-right direction.

With reference to FIG. 2, the plate 200 defines apertures 220 extended in the top-bottom direction. The apertures 220 are defined along a first boundary 222 and a second boundary 224 in the front-back direction. The first boundary 222 and the second boundary 224 are imaginary lines sized, shaped, and located on the plate 200 such that the defined apertures 220 overlap a portion of the impeller 140 in the top-bottom direction. The first boundary 222 and the second boundary 224 are rounded around the shaft 134 in the left-right direction and the front-back direction, corresponding to a circular shape of the impeller 140. In this regard, at any point along the first boundary 222 or the second boundary 224, a direction orthogonal to the boundary includes a first vector component in the left-right direction and a second vector component in the front-back direction that are each directed toward the shaft 134. In further embodiments, the first boundary 222 or the second boundary 224 may be circular and centered on the shaft 134, evenly distributing material onto the impeller 140 from the hopper 102.

The apertures 220 are spaced from each other in the left-right direction a distance that overlaps a front-facing portion of the impeller 140. With this construction, the plate 200 limits material flow from the hopper 102 to the front-facing portion of the impeller 140. As such, a throw direction of the material from the material spreader 100 at the impeller 140 is limited to a range extended from the front-facing portion of the impeller 140, corresponding to the apertures 220.

The plate 200 includes cross supports 230 extended between the first boundary 222 and the second boundary 224 in the front-back direction, connecting opposite sides of the main body portion 212 along the apertures 220. The cross supports 230 are interposed between and separate the apertures 220 in the left-right direction. With this construction, the cross supports 230 brace the opposite sides of the main body portion 212 at the apertures 220, inhibiting deformation under loading by material flow from the hopper 102 and through the apertures 220 under gravity.

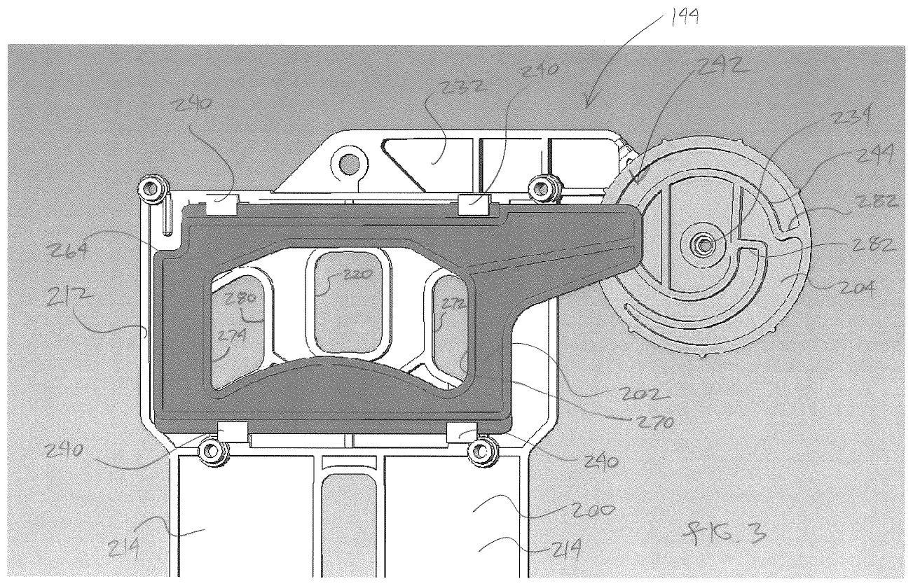

The plate 200 includes an arm 232 that extends outward from the main body portion 212 in the left-right direction. The arm 232 supports the wheel 204 on the plate 200. In this regard, as shown in FIG. 3, the arm 232 forms a hub 234, and the wheel 204 is pivotally fixed to the plate 200 through the arm 232 at the hub 234. The slide 202 is retained with the plate 200 in the top-bottom direction in channels 240 formed from the plate 200. In this manner, the slide 202 is directly mounted on the plate 200, where the slide 202 is retained to the plate 200 by direct contact with the channels 240, without an unfixed intermediary component between the channels 240 and the slide 202.

The channels 240 extend along the main body portion 212 and the arm 232 in the left-right direction. The channels 240 are each formed from a series of ribs that collectively support and retain the slide 202 with the plate 200 in the top-bottom direction, while allowing the slide 202 to travel relative to the plate 200 in the left-right direction. More specifically, the channels 240 retain the slide 202 relative to the plate 200 in the top-bottom direction and in a front-back direction orthogonal to the left-right direction and the top-bottom direction, while allowing the slide 202 to travel relative to the plate 200 in the left-right direction.

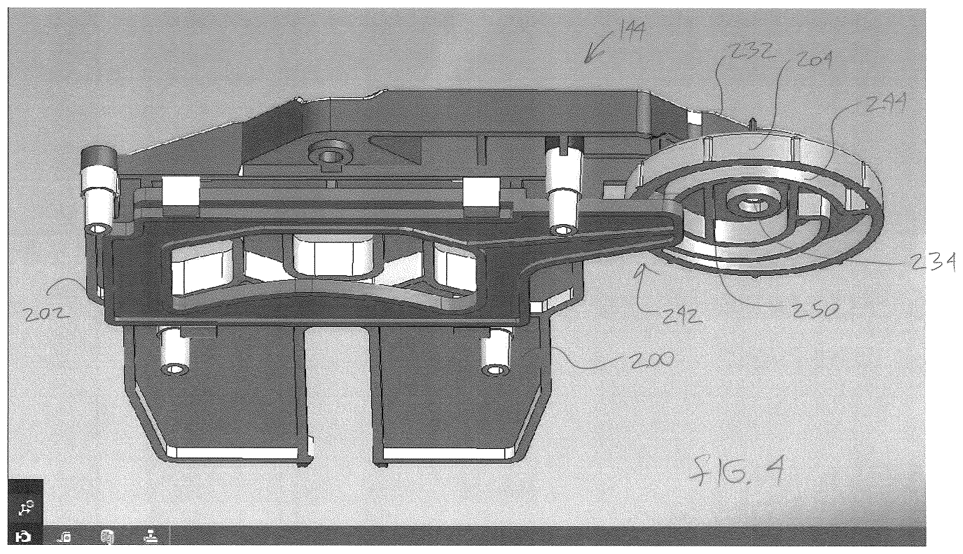

The slide 202 is operably connected to the wheel 204 through a cam mechanism 242, which forms part of the user actuated adjustment mechanism that drives and positions the slide 202 relative to the plate 200. In this regard, the wheel 204 forms a spiral cam groove 244 that has varying, or inclined radial distance from the hub 234 that gradually changes as the wheel 204 is rotated relative to the slide 202. As shown in FIG. 4, the slide 202 includes a cam follower 250 engaged with the spiral cam groove 244.

With this construction, the cam follower 250 pushes or pulls the slide 202 in the left-right direction based on a rotation of the wheel 204, and a changing distance between the spiral cam groove 244 and the hub 234 in the left-right direction. As such, the cam mechanism 242 drives the slide 202 in the first linear direction when a user rotates the wheel 204 in the first rotational direction, and drives the slide 202 in the second linear direction when a user rotates the wheel 204 in the second rotational direction. In this manner, a user may drive the slide in the first linear direction or the second linear direction by rotating the wheel 204.

In an alternative embodiment, the slide 202 is operably connected to the wheel 204 through a rack and pinion mechanism, which forms part of the user actuated adjustment mechanism that drives and positions the slide 202 relative to the plate 200. In such an embodiment, the slide 202 and the wheel 204 include complementary gears, teeth, or other interlocking parts that cause the slide 202 to travel in the left-right direction when a user rotates the wheel 204.

Referring back to FIG. 2, the wheel 204 includes a series of protuberances 252 that extend outward from an outer periphery 254 in the front-back direction and the left-right direction. The protuberances 252 form grip features that enable a user to grip and rotate the wheel 204, driving the slide 202 in the left-right direction.

The wheel 204 also includes first visual indicators 260 that selectively correspond to a second visual indicator 262 included on the plate, indicating a position of the wheel 204 and the slide 202 relative to the plate 200. In this manner, the plate 200 and the wheel 204 indicate a linear position of the slide 202 relative to the plate 200 in the left-right direction.

As depicted, the first visual indicators 260 are alphanumeric indicators, and the second visual indicator 262 is an arrow formed from the arm 232. The second visual indicator 262 points to one of the first visual indicators 260 at a time based on a rotational position of the wheel 204. In this manner, one of the first visual indicators 260 corresponds to the second visual indicator 262 at a time, signaling to a user the linear position of the slide 202.

With continued reference to FIG. 2, the slide 202 includes a damper 264 that selectively occludes the apertures 220 from the opening of the hopper 102 in the top-bottom direction, optionally in a direction of gravity, based on the linear position of the slide 202 actuated by user input. The damper 264 is a sliding cover that may completely or partially cover the apertures 220 based on the linear position of the slide 202. With this construction, a user may rotate the wheel 204 to selectively occlude the apertures 220, directing flow of material through the apertures 220 and onto a desired area of the front-facing portion of the impeller 140 in the left-right direction. More specifically, a user may control the throw direction from the material spreader at the front-facing portion of the impeller 140 in the left-right direction by rotating the wheel 204 in the first rotational direction or the second rotational direction. In this manner, a user may control where material from the hopper 102 travels through the plate 200, contacts the impeller 140, and is consequently discharged from the material spreader 100 in the left-right direction.

As shown in FIG. 3, the damper 264 is formed from a plate defining an aperture with a first damper edge 270 that occludes a first aperture 272 of the apertures 220 by a dimension “A”. The damper 264 also defines the aperture with a second damper edge 274 that occludes a second aperture 280 of the apertures 220 by a dimension “B” in the left-right direction. A user adjusts dimensions “A” and “B” by rotating the wheel 204, augmenting the linear position of the slide 202.

The linear position of the slide 202 relative to the plate 200 is limited between a first position and a second position defined by ends 282 of the spiral cam groove 244. In this regard, the slide 202 is obstructed from travel beyond the first position or the second position when the cam follower 250 abuts one of the ends 282 of the spiral cam groove 244. In embodiments, the first position of the slide 202 corresponds to a position of the slide 202 in which the damper 264 occludes the at least one aperture 220 at a first side of the impeller 140 in the left-right direction, such that material discharged from the hopper 102 is directed onto the first side of the impeller 140. In such embodiments, the second position of the slide 202 corresponds to a position of the slide 202 in which the damper 264 occludes the at least one aperture 220 at a second side of the impeller 140 opposite the first side in the left-right direction, such that material discharged from the hopper 102 is directed onto the second side of the impeller 140. With this construction, rotation of the wheel 204 in the first rotational direction drives the slide 202 and the damper 264 in the first linear direction toward the first position, and rotation of the wheel 204 in the second rotational direction drives the slide 202 and the damper 264 in the second linear direction toward the second position.

With reference to FIG. 2, in an embodiment, the first position corresponds to the first damper edge 270 aligned with an outer edge 284 of the first aperture 272 such that the “A” dimension is zero, and the second position corresponds to the second damper edge 274 aligned with an outer edge 290 of the second aperture 280. A distance between the outer edge 284 of the first aperture 272 and the outer edge 290 of the second aperture 280 in the left-right direction is greater than a distance between the first damper edge 270 and the second damper edge 274 in the left-right direction. In such an embodiment, the slide 202 may be actuated between the first position and the second position while maintaining a constant amount of occlusion of the apertures 220. In this manner, a user may actuate the slide 202 to control a discharge direction of material from the material spreader 100 while maintaining a constant rate of material flow from the hopper 102 to the impeller 140.

In embodiments, the at least one aperture 220 includes a first side and a second side opposite the first side in the left-right direction, where the first side of the at least one aperture 220 corresponds to the first outer edge 284 and the second side of the at least one aperture 220 corresponds to the second outer edge 290. With this construction, movement of the slide 202 and the damper 264 in the left-right direction based on rotation of the wheel 204 selectively occludes the at least one aperture 220 at the first side or at the second side opposite the first side in the left-right direction.

In a further embodiment, the first position of the slide 202 corresponds to the second damper edge 274 aligned with an inner edge 292 of the second aperture 280, and the second position of the slide 202 corresponds to the first damper edge 270 aligned with an inner edge 294 of the first aperture 272. With this construction, an amount of occlusion between the first aperture 272, the second aperture 280, and the damper 264 remains constant when a user adjusts the linear position of the slide 202, and the material flow through the apertures 220 remains constant between the first aperture 272 and the second aperture 280.

When the transfer balance system 144 is assembled in the material spreader 100, the first aperture 272 is defined in the plate 200 at a first side of the shaft 134 in the left-right direction, and the second aperture 280 is defined in the plate 200 at a second side of the shaft 134 opposite the first side in the left-right direction. In this manner, the at least one aperture 220 collectively extends across opposite sides of the shaft 134 in the left-right direction. As such, material flowing through the first aperture 272 and the second aperture 280 respectively contacts the impeller 140 at opposite sides of the shaft 134 in the left-right direction.

With the wheels 110 oriented in the front-back direction, this configuration provides control over a direction of material spreading from the impeller 140 in the left-right direction as the material spreader 100 travels in the front-back direction. In this regard, the damper 264 selectively occludes the at least one aperture 220 at a first side of the shaft 134 or at a second side of the shaft 134 opposite the first side in the left-right direction based on user input, thereby facilitating control and adjustment of the direction of material spreading from the impeller 140.

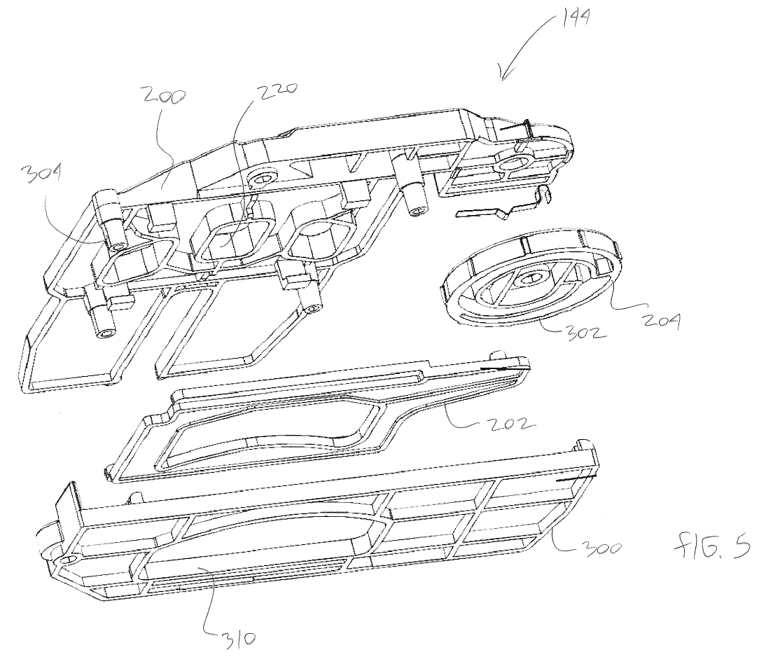

FIG. 5 depicts a perspective exploded view of the transfer balance system 144, including a cover 300. The cover 300 engages the plate 200, encases the slide 202, and covers a bottom portion 302 of the wheel 204 in the top-bottom direction. The plate 200 forms a series of bosses 304 that engage the cover 300, fixing the cover 300 to the plate 200. In an embodiment, fasteners such as screws may be inserted through the bosses 304 and engaged with the cover 300, fixing the cover 300 with the plate 200.

The cover 300 defines a hole 310 below the apertures 220 in the top-bottom direction. The hole 310 overlaps all of the apertures 220 in the top-bottom direction. With this construction, the cover 300 avoids obstructing material flow from the apertures 220 to the impeller 140, regardless of the linear position of the slide 202.

A position of the cover 300 is adjustable in the left-right direction relative to the plate 200 and the slide 202. In this regard, the apertures 220 include a third aperture 312 that is interposed between and separates the first aperture 272 and the second aperture 280 in the left-right direction. The third aperture 312 is defined between the cross supports 230 in the left-right direction, and between the first boundary 222 and the second boundary 224 in the front-back direction.

As shown in FIG. 2, the third aperture 312 is defined in the plate 200 at a same position as the shaft 134 in the left-right direction, such that the third aperture 312 is laterally aligned with the shaft 134 in the front-back direction, and centered between the first aperture 272 and the second aperture 280. With this construction, the third aperture 312 is located directly behind the shaft 134 in the front-back direction, and corresponds to a central direction of material flow from the impeller 140 as compared to material flow from the impeller 140 through the first aperture 272 and the second aperture 280.

Referring back to FIG. 5, a user may actuate the cover 300 in a first linear direction in the left-right direction, where the cover 300 occludes the first aperture 272 and the third aperture 312. A user may also actuate the cover 300 in a second linear direction in the left-right direction, where the cover 300 occludes the second aperture 280 and the third aperture 312. In embodiments, movement of the cover 300 based on the second user input positions the cover 300 such that the cover 300 occludes an entirety of the first aperture 272, or alternatively occludes an entirety of the second aperture 280, fully blocking material flow through the first aperture 272 or the second aperture 280 while permitting material flow through the other of the first aperture 272 and the second aperture 280. In further embodiments, the cover 300 may additionally occlude the third aperture 312, wholly or in part, while occluding the first aperture 272 or the second aperture 280 based on user input.

In this manner, the cover 300 selectively occludes the apertures 220 from the opening of the hopper 102 in the top-bottom direction, guiding material flow from the hopper 102 and toward the impeller 140 by gravity. In embodiments, actuation of the slide 202 and the damper 264 based on rotation of the wheel 204 corresponds to a first user input, and movement of the cover 300 relative to the plate 200 and the damper 264 corresponds to a second user input independent from the first user input. With this construction, the cover 300 is movable relative to the plate 200 and the damper 264 based on the second user input, selectively occludes the apertures 220 and in this manner guides material flow through the hole 310 and toward the impeller 140 by gravity. While, as depicted, the apertures 220 include three apertures in the first aperture 272, the second aperture 280, and the third aperture 312, the apertures 220 may include more or fewer apertures, referred to herein as at least one aperture, without departing from the scope of the present disclosure.

Referring back to FIG. 2, the cover 300 includes a slot 314 that engages one of the bosses 304 extended from the plate 200 in a sliding relationship. With this construction, the cover 300 is retained in the sliding relationship with the plate 200 at the slot 314, where the cover 300 is fixed with the plate 200 in the top-bottom direction and the front-back direction, and may travel in the left-right direction relative to the plate 200.

In this manner, the cover 300 performs border control, where the throw direction of the material is selectively confined to one side of the material spreader 100. More specifically, by occluding either the first aperture 272 and the third aperture 312 or the second aperture 280 and the third aperture 312, the cover 300 limits the flow of granular material to the impeller 140, and thereby limits application of the material to a desired lateral region. Such targeted control by the cover 300 prevents inadvertent application of the material to adjacent, non-targeted regions, ensuring that a corresponding spread pattern of the material adheres to associated requirements, such as specific regulatory and operational requirements, and enhances precision and efficiency of material distribution by the material spreader 100.

The slide 202 and the cover 300 are actuated independently from each other, providing enhanced control over material distribution from the material spreader 100. In this regard, the slide 202 is adjusted separately with the wheel 204 to regulate the overall flow of granular material to the impeller 140, while the cover 300 is independently positioned to define the lateral boundaries of the spread pattern. The decoupled actuation of the slide 202 and the cover 300 enables users to fine-tune the throw direction of material without inadvertently dispersing material outside a desired region. As such, adjustments to the throw direction by the slide 202 do not exceed borders of the material spread set by the cover 300.

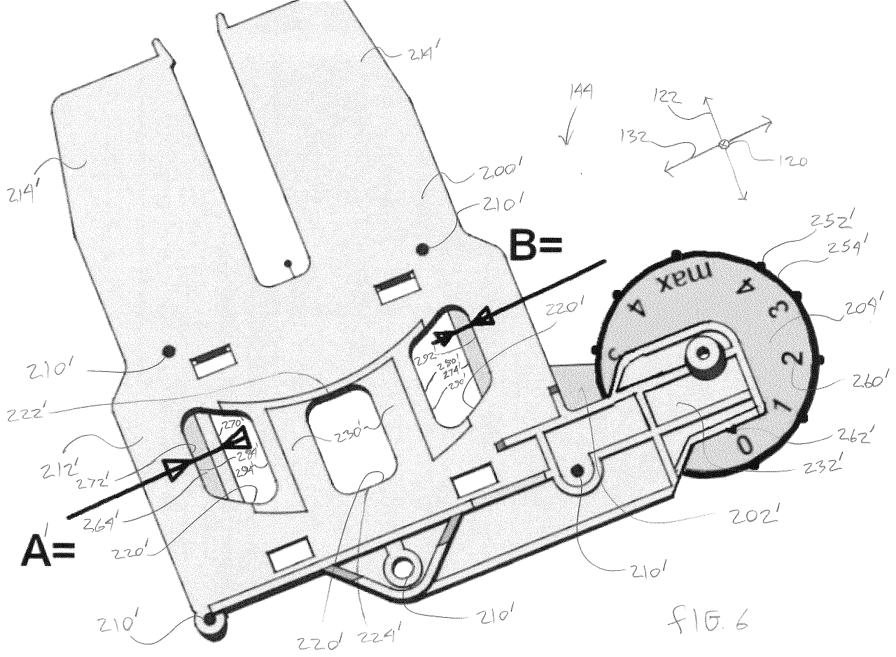

FIG. 6 depicts an alternate embodiment of the transfer balance system 144 of FIGS. 1-5 . In the embodiment of FIG. 6, like elements with the transfer balance system 144 of FIGS. 1-5 are denoted with the same reference numerals but followed by a primed suffix (′).

The anchors 210 are spaced from each other along the plate 200 in the front-back direction and the left-right direction such that the recesses engage the wall 150 at opposite sides of the opening. With this construction, the anchors 210 support the plate 200 from across opposite sides of the opening in the front-back direction and the left-right direction.

While, as depicted in FIG. 1, the material spreader 100 is a walk-behind spreader that may be pushed or pulled by a user over a target area, the material spreader 100 may additionally or alternatively include a variety of devices for transporting the hopper 102 and driving the shaft 134 without departing from the scope of the subject disclosure. In this regard, the material spreader 100 may alternatively be mounted or operably connected to a powered vehicle operated by a user for dispersing contents from the hopper 102.

While specific embodiments are shown and described herein, it is contemplated that alternative embodiments exist that employ alternative materials, mixtures, proportions, sizes, etc. without departing from the spirit and/or scope of the innovation as described in detail. These alternative embodiments are to be included within the spirit and scope of the innovation as described and claimed herein.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, the term “in” as used to describe an object with respect to a given direction (e.g., an edge extended in a left-right direction) is intended to denote an orientation that is substantially parallel to the specified direction. In contrast, the term “along” as used to describe an object with respect to a given direction (e.g., an edge extended along a vertical direction) is intended to indicate that a feature or element possesses a common vector component in that direction, even if its overall alignment is not strictly parallel.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited thereto.

It will be appreciated that various embodiments of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A material spreader comprising:
a hopper defining an interior that contains material, and defining an opening that discharges the material from the interior by gravity;
a plate positioned below the opening, wherein the plate defines at least one aperture that guides material flow from the hopper;
a damper that selectively occludes the at least one aperture from the opening in a direction of gravity based on user input; and
an impeller positioned below the damper.

2. The material spreader of claim 1, wherein the damper is formed from a slide mounted on the plate, where the slide is movable relative to the plate in a linear direction orthogonal to gravity.

3. The material spreader of claim 2, further comprising a set of wheels fixed relative to the hopper and oriented in a front-back direction, wherein the linear direction is a left-right direction orthogonal to the front-back direction.

4. The material spreader of claim 2, wherein the linear direction is a left-right direction and the slide is directly mounted on the plate, where the plate defines a channel that retains the slide in a top-bottom direction orthogonal to the left-right direction, or retains the slide in a front-back direction orthogonal to the left-right direction and the top-bottom direction.

5. The material spreader of claim 1, further comprising a wheel operably connecting the plate to the damper such that:
rotating the wheel in a first rotational direction drives the damper in a first linear direction, where the damper occludes the at least one aperture at a first side of the impeller; and
rotating the wheel in a second rotational direction opposite the first rotational direction drives the damper in a second linear direction opposite the first linear direction, where the damper occludes the at least one aperture at a second side of the impeller opposite the first side along the first linear direction or the second linear direction.

6. The material spreader of claim 5, wherein the wheel is pivotally mounted on the plate, the wheel includes a spiral cam groove, the damper is formed from a slide fixed to the plate, and the slide includes a cam follower positioned within the spiral cam groove, operably connecting the plate to the damper such that the wheel drives the damper in the first linear direction or the second linear direction.

7. The material spreader of claim 1, further comprising:
a cover that selectively occludes the at least one aperture from the opening in the direction of gravity, guiding material flow from the hopper and toward the impeller by gravity, wherein the user input is a first user input, and the cover is movable relative to the plate and the damper based on a second user input.

8. The material spreader of claim 7, further comprising:
a set of wheels fixed relative to the hopper and oriented in a front-back direction; and
a shaft that transfers torque to the impeller,
wherein the at least one aperture includes a first aperture defined in the plate at a first side of the shaft in a left-right direction orthogonal to the front-back direction, and a second aperture defined in the plate at a second side of the shaft opposite the first side in the left-right direction, and
the cover is movable in the left-right direction relative to the plate and the damper based on the second user input, where the cover occludes the first aperture or the second aperture.

9. The material spreader of claim 8, wherein the at least one aperture includes a third aperture positioned between the first aperture and the second aperture in the left-right direction, having a same position as the shaft in the left-right direction, and
the cover is movable in the left-right direction, where the cover occludes the first aperture and the third aperture, or occludes the second aperture and the third aperture.

10. The material spreader of claim 1, further comprising a shaft that transfers torque to the impeller, wherein the at least one aperture extends across the shaft in a left-right direction, the at least one aperture is rounded around the shaft in a front-back direction orthogonal to the left-right direction, and the damper selectively occludes the at least one aperture at a first side of the shaft or a second side of the shaft opposite the first side in the left-right direction based on the user input.

11. A transfer balance system, comprising:
a plate that defines at least one aperture, and includes anchors;
a slide fixed with the plate in a top-bottom direction, wherein the slide includes a damper; and
a user actuated adjustment mechanism that drives the slide relative to the plate in a left-right direction orthogonal to the top-bottom direction through a manual user input, where the damper selectively occludes the at least one aperture in the top-bottom direction based on the user input.

12. The transfer balance system of claim 11, wherein the plate defines a channel that retains the slide in the top-bottom direction and a front-back direction orthogonal to the left-right direction and the top-bottom direction.

13. The transfer balance system of claim 11, wherein the user actuated adjustment mechanism includes a wheel operably connecting the plate to the slide such that:
rotating the wheel in a first rotational direction drives the damper relative to the plate in a first linear direction along the left-right direction, where the damper occludes a first side of the at least one aperture; and
rotating the wheel in a second rotational direction opposite the first rotational direction drives the damper in a second linear direction opposite the first linear direction, where the damper occludes a second side of the at least one aperture opposite the first side in the first linear direction or the second linear direction.

14. The transfer balance system of claim 13, wherein the wheel defines a spiral cam groove,
the slide includes a cam follower positioned within the spiral cam groove, where the wheel drives the slide in the left-right direction based on the manual user input,
the damper defines a first damper edge and a second damper edge opposite the first damper edge in the left-right direction,
the plate defines the at least one aperture along a first outer edge and a second outer edge opposite the first outer edge in the left-right direction, and
the wheel defines the spiral cam groove with opposing ends that limit travel of the follower and the slide between a first position and a second position.

15. The transfer balance system of claim 11, wherein the user actuated adjustment mechanism limits movement of the slide relative to the plate in the left-right direction between a first position and a second position,
the damper defines a first damper edge and a second damper edge opposite the first damper edge in the left-right direction,
the plate defines the at least one aperture along a first outer edge and a second outer edge opposite the first outer edge in the left-right direction,
the first damper edge is aligned with the first outer edge when the slide is in the first position, and
the second damper edge is aligned with the second outer edge when the slide is in the second position.

16. The transfer balance system of claim 11, wherein
the user actuated adjustment mechanism limits movement of the slide relative to the plate in the left-right direction to between a first position and a second position,
the damper defines a first damper edge and a second damper edge opposite the first damper edge in the left-right direction,
the plate defines the at least one aperture along a first outer edge and a second outer edge opposite the first outer edge in the left-right direction,
the first damper edge is aligned with the first outer edge when the slide is in the first position, and
the damper maintains a constant amount of occlusion of the at least one aperture when moving between the first position and the second position.

17. The transfer balance system of claim 11, wherein the plate defines the at least one aperture with a first outer edge and a second outer edge opposite the first outer edge in the left-right direction,
the damper includes a first damper edge that occludes the at least one aperture at the first outer edge, and includes a second damper edge opposite the first damper edge in the left-right direction, where the second damper edge occludes the at least one aperture at the second outer edge, and
a distance between the first outer edge and the second outer edge in the left-right direction is greater than a distance between the first damper edge and the second damper edge in the left-right direction.

18. The transfer balance system of claim 11, further comprising a cover fixed with the plate, wherein the user input is a first user input, the cover is movable relative to the plate and the slide along the left-right direction through a second user input such that the cover selectively occludes the at least one aperture in the top-bottom direction.

19. The transfer balance system of claim 18, wherein the cover is fixed in a sliding relationship with the plate in the left-right direction, at a same side of the plate as the slide in the top-bottom direction, the cover being retained relative to the plate in the top-bottom direction and a front-back direction orthogonal to the left-right direction and the top-bottom direction.

20. The transfer balance system of claim 18, wherein the at least one aperture includes a first aperture and a second aperture offset from the first aperture in the left-right direction, and the cover selectively occludes an entirety of the first aperture or an entirety of the second aperture based on the second user input.
